(19) United States
(12) Patent Application Publication
(10) Pub. No.: US 2023/0221202 A1
(43) Pub. Date: Jul. 13, 2023

(54) PRESSURE SENSOR FORMED BY STRAIN GAUGE ON A DEFORMABLE MEMBRANE OF A FLUID DEVICE

(71) Applicant: ROTAREX S.A., Lintgen (LU)

(72) Inventors: Thomas ANDREAS, Temmels (DE); Philippe SCHMITZ, Steinsel (LU)

(21) Appl. No.: 18/009,837

(22) PCT Filed: Jun. 10, 2021
(86) PCT No.: PCT/EP2021/065569

§ 371 Date: Dec. 12, 2022

(30) Foreign Application Priority Data
Jun. 10, 2020 (LU) LU 101845

(51) Int. Cl. G01L 9/00; G01L 19/00

(52) U.S. Cl. CPC G01L 9/0051; G01L 19/0092

(57) ABSTRACT

A fluid device comprising a body with a membrane extending in a mean plane and showing an inner face and an outer face; a strain gauge arranged on the outer face of the membrane for measuring a deformation of the membrane when a fluid pressure is applied on the inner face thereof; wherein a bore is formed in the body, extending along an axis parallel to the mean plane of the membrane and delimiting a passage for the fluid under pressure, in fluid connection with the inner face of the membrane.

### CROSS-REFERENCE TO RELATED APPLICATIONS

The present invention is the US national stage under 35 U.S.C. § 371 of International Application No. PCT/EP2021/065569 which was filed on Jun. 10, 2021, and which claims the priority of application LU101845 filed on Jun. 10, 2020 the contents of which (text, drawings and claims) are incorporated here by reference in its entirety.

### FIELD

The invention is directed to the field of fluid pressure measurement and more particularly to the field of the pressure measurement of gas under high pressure (>200 bar).

### BACKGROUND

Fluid pressure sensors are generally known and commercially available. They very often comprise a body with a deformable membrane with a strain gauge applied on an outer face thereof. The deformable membrane is usually attached to the body, e.g., by soldering. The body usually comprises a thread and/or a circular front surface for providing a fluid tight connection with a device onto which the sensor is mounted. That kind of pressure sensor is interesting and practical for limited pressures. For application with higher pressure, e.g., >200 bar, as for industrial gases, such pressure sensors are less practical due to the potential leaks that might result and also to potential material incompatibility like hydrogen embrittlement. Also, most of the commercially available pressure sensors compatible for such higher pressures do not provide a high accuracy which is otherwise desired for properly interpreting pressure variations in gas cylinders.

Prior art patent document published U.S. Pat. No. 6,062,088 discloses a pressure sensor with a threaded body and an integrally formed deformable membrane. Deformation of the membrane is sensed by means of a piezo-resistive resistor element forming a bridge over the membrane. The bridge element is rigidly attached to the body by soldering. This requires a particular care and can lead to a lack of accuracy.

Prior art patent document published US 2017/0328796 A1 discloses a fluid pressure sensor comprising also a body and a deformable membrane integrally formed with the body. Pressure gauges are applied directly on an outer face of the membrane. The body forms a nipple with a cavity surrounding the outer face of the membrane. The fluid pressure sensor requires however to be mounted to a device or piece of equipment handling the fluid under pressure.

### SUMMARY

The invention has for technical problem to overcome at least one of the drawbacks of the above cited prior art. More particularly, the invention has for technical problem to provide a solution for measuring a fluid pressure with a safer and more accurate way, in particular with a higher level of integration.

The invention is directed to a fluid device comprising: a body with a membrane extending in a mean plane and showing an inner face and an outer face; a strain gauge arranged on the outer face of the membrane for measuring a deformation of the membrane when a fluid pressure is applied on the inner face thereof; wherein a bore is formed in the body, extending along an axis parallel to the mean plane of the membrane and delimiting a passage for the fluid under pressure in fluid connection with the inner face of the membrane.

According to an exemplary embodiment, the strain gauge shows an axis of maximum sensitivity, the strain gauge being positioned on the inner face of the membrane such that the axis of maximum sensitivity is perpendicular to the axis of the bore delimiting a passage for the fluid under pressure.

According to an exemplary embodiment, the bore delimiting a passage for the fluid under pressure forms the inner face of the membrane.

According to an exemplary embodiment, the membrane is integrally formed with the body.

According to an exemplary embodiment, the outer face of the membrane is circular and shows a diameter d. Advantageously, d is at least 8 mm, in various instances at least 10 mm, for example at least 12 mm. Advantageously, d is less than 20 mm, in various instances less than 15 mm.

According to an exemplary embodiment, the bore delimiting a passage for the fluid under pressure shows a diameter D that is larger than the diameter d.

According to an exemplary embodiment, the bore delimiting a passage for the fluid under pressure shows a diameter D that is less than the diameter d.

According to an exemplary embodiment, the diameter d is comprised between 8 and 14 mm and the membrane shows at a central position a thickness t comprised between 0.5 and 1.0 mm.

According to an exemplary embodiment, the outer face of the membrane is planar.

According to an exemplary embodiment, the fluid device is designed for working at a fluid pressure of up to a maximum pressure Pₘₐₓ, the membrane being designed for showing a maximal strain at the maximum pressure Pₘₐₓ that is not greater than 0.2%.

According to an exemplary embodiment, the bore delimiting a passage for the fluid under pressure is a first bore, a second bore being formed in the body extending along an axis transversal, in various instances perpendicularly, to the axis of the first bore and forming a cavity housing the membrane.

According to an exemplary embodiment, the strain gauge shows a gauge factor g of at least 5, in various instances at least 20, for example at least 30.

According to an exemplary embodiment, the strain gauge shows a resistance R which varies according to the following formula:

$$\frac{Δ R}{{R}_{0}} = {e}^{g \cdot ε} - 1$$

where R₀ is a nominal resistance of the strain gauge, g a gauge factor and e a stretching deformation of the strain gauge.

According to an exemplary embodiment, the fluid device further comprises an electronic unit electrically connected to the strain gauge and configured for outputting a signal representative of the fluid pressure.

According to an exemplary embodiment, the fluid device further comprises a temperature sensor of the fluid electrically connected to the electronic unit, wherein the electronic unit is configured for outputting a signal representative of the mass of fluid available based on a variation of pressure while the fluid is outputted.

According to an exemplary embodiment, the fluid device further comprises a fluid shut-off valve.

The invention is particularly interesting in that it provides a secure way of measuring fluid pressures over a wide range and with a satisfying accuracy over that range. Integrating the deformable membrane in the fluid device body, in various instances in a unitary manner, provides a secure way of measuring high fluid pressures. The layout and thickness of the membrane are selected for achieving a satisfying sensitivity over a large range of pressure, i.e., from a few bar to a few hundred bar. This is particularly useful for gas cylinders with a nominal pressure (i.e., when totally filled) of a few hundred bar (e.g., 200, 250, 300 bar), outputting via a pressure reducer a gas delivery flow at a few bar, meaning that the gas cylinder is operational until the inner pressure reaches or approaches the reduced output pressure. In such application, it is important to a have an accurate pressure measurement for determining based on such measurements, a temperature detection and the ideal/real gas law, a total amount of gas in the gas cylinder.

The invention challenges the contradictory requirements of (i) increasing the security with regard to leakage and (ii) achieving an accurate pressure measurement with a good sensitivity over a large range of pressure. Requirement (i) is achieved by forming the membrane inside the body, in various instances unitary with the body, and requirement (ii) is achieved by providing adequate dimensions to the membrane and providing an adequate stain gauge, adequately positioned.

### DRAWINGS

FIG. 1 is a perspective view of a fluid device according to various embodiments of the invention.

FIG. 2 is a longitudinal view and a cross-sectional view of the fluid device of FIG. 1, according to various embodiments of the invention.

FIG. 3 is a longitudinal sectional view of the body of the fluid device of FIGS. 1 and 2, showing FEM meshing, according to various embodiments of the invention.

FIG. 4 is a cross-sectional view of the body of FIG. 3, showing an amplified deformation of the membrane under fluid pressure, according to various embodiments of the invention.

FIG. 5 is a front view of the membrane of the body of FIGS. 3 and 4, showing a distribution of the stress in the membrane at the outer face in the y direction, according to various embodiments of the invention.

FIG. 6 is a graphic showing the stress distribution in the membrane of the body of FIGS. 3 to 5, taken along a central direction perpendicular to the longitudinal axis of the body, according to various embodiments of the invention.

FIG. 7 is a front view of the membrane of the body of 3 and 4, showing a distribution of the strain in the membrane at the outer face in the y direction, according to various embodiments of the invention.

FIG. 8 is a graphic showing the strain distribution in the membrane of the body of FIGS. 3 to 5, taken along a central direction perpendicular to the longitudinal axis of the body, according to various embodiments of the invention.

FIG. 9 is a graphic showing the maximum strain in the membrane depending on the pressure in the body of FIGS. 3-5 and 7, according to various embodiments of the invention.

FIG. 10 show variants of the body of a fluid device according to various embodiments of the invention.

### DETAILED DESCRIPTION

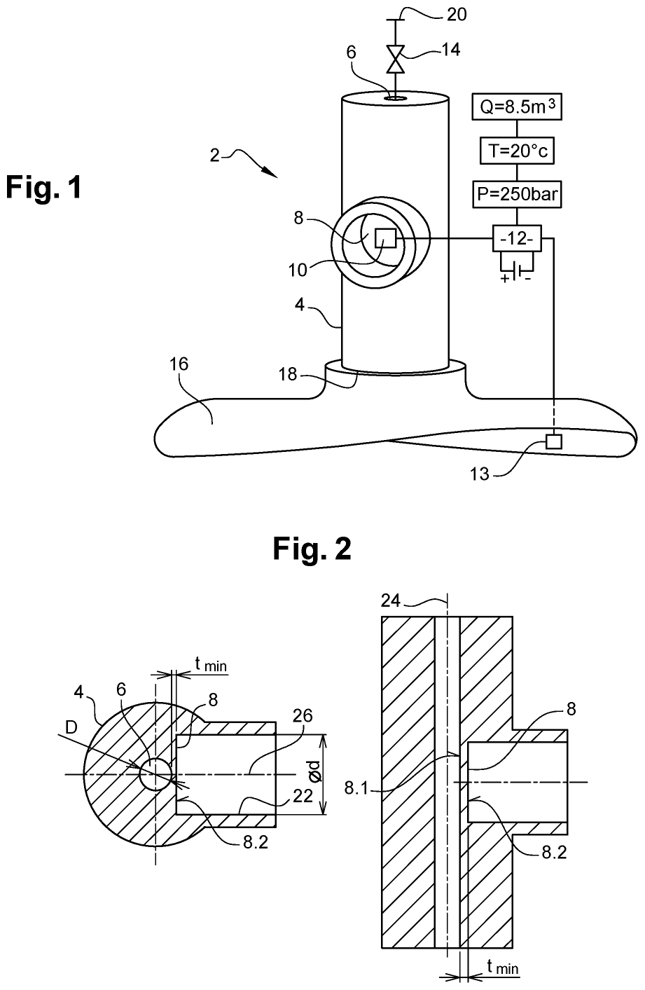

FIG. 1 is a perspective view of a fluid device according to various embodiments of the invention. The fluid device 2 comprises a body 4 into which a bore 6 is formed. A fluid, for instance a gas, can be provided under pressure in the bore 4. The body 4 is also provided with a membrane 8 with an inner face that is in contact with the fluid under pressure and an outer face onto which a strain gauge 10 is applied. The strain gauge 10 is electrically connected to an electronic unit 12 which is configured for outputting a signal representative of the fluid pressure based on a deformation of the membrane measured by the strain gauge 10.

The fluid device 2 comprises for instance a shut-off valve 14 and is designed for being mounted on a gas cylinder 16. It comprises a gas inlet 18 at a first end of the body 4 screwed in a gas tight fashion into a neck of the gas cylinder 16. The fluid device 2 comprises a gas outlet 20 for connecting to another device like a pressure reducer. The fluid device 2 can comprise, in an integrated fashion, a pressure reducer.

The fluid device 2 of the invention can take various shapes and configurations provided it comprises a body with a bore for containing a fluid under pressure and a membrane with an inner face in contact with the fluid under pressure in the bore. It can indeed be a mere fluid connection device or a more sophisticated fluid device like a shut-off valve, pressure reducer and/or flow selector for gas.

The electronic unit 12 can also be electrically connected to a temperature sensor 13 which is advantageously located on the wall of the gas cylinder 16, being however understood that it can also be located in the body 4, in contact with the gas under pressure in the gas cylinder 16. Based on the measured temperature and pressure, the electronic unit can, using the perfect gas law or a real gas law (with adequate correction factors depending on the type of gas), deduct the quantity of gas in the gas cylinder, expressed in mass (e.g., kg) or volume (e.g., m³). The correction factor, often named Z, depends on the pressure and temperature of the gas. It can therefore be stored in one or more lookup tables in a memory of a microcontroller, providing values for different temperatures and different pressures, and/or be calculated based on coefficients that can also depend on the temperature and therefore also stored in one or more lookup tables. Thereby an accurate calculation of the mass of gas contained in the gas cylinder can be performed. Also the variation of mass over time, corresponding to the consumption flow rate, can also be calculated. From the mass of gas contained in the gas cylinder and the flow rate, a remaining usage time can be calculated.

FIG. 2 shows two sectional views of the body 4 of the fluid device 2 of FIG. 1. The left view is a cross-sectional view whereas the right view is a longitudinal-sectional view.

As this is apparent, the membrane 8 is integrally formed with the body 4. It shows an inner face 8.1 that is in direct contact with the fluid under pressure in the bore 6. More specifically, the inner face 8.1 is formed by a portion of the inner face of the bore 6. In the present case the inner face 8.1 is curved, i.e., a portion of a cylindrical surface. The membrane 8 shows also an outer face 8.2 that is opposed to the inner face 8.1. The outer face 8.2 is for instance flat, i.e., planar. In certain embodiments, it can be non-planar.

For the membrane 8 to be integrally formed with the body 4, a transversal bore 22 is formed, i.e., a bore that is transversal, in various instances perpendicular to the longitudinal axis of the bore 6. The transversal bore 22 shows a diameter D and the longitudinal bore 6 shows a diameter d. In the present case, d<D being however understood that d can be equal to or greater than D.

The membrane 8 shows then a variable thickness with a minimum value train at a central position, i.e., at an intersection of the membrane 8 with the transversal axis 26 of the transversal bore 22.

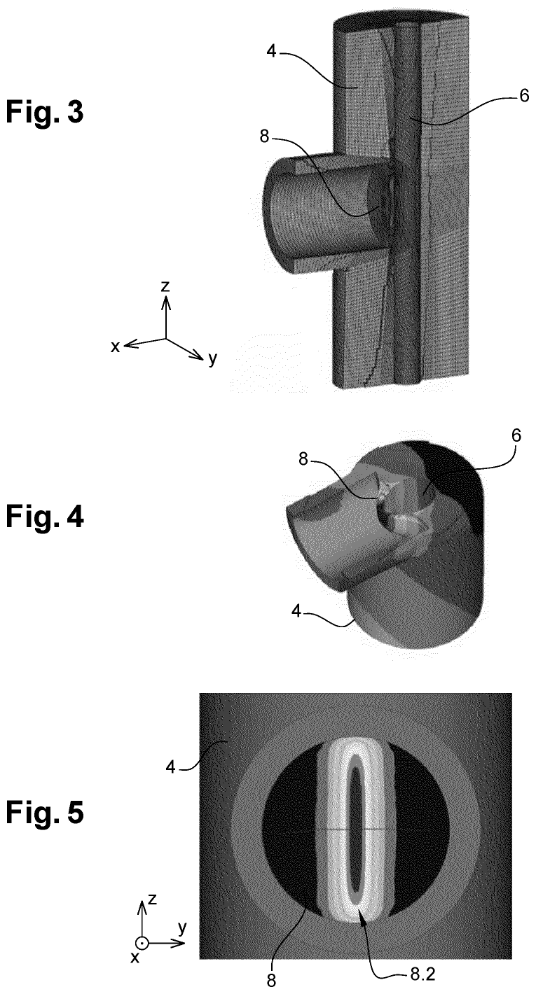

FIGS. 3 to 9 relate to a Finite Element Method (FEM) analysis of the body 4 of the fluid device 2 of FIGS. 1 and 2, where the stresses and strains in the membrane 8 when a fluid is under pressure in the bore 6 have been analysed.

For instance, the material of the body 4 is brass, more specifically CuZn40Pb2 with an elasticity modulus E=97 000 MPa, a yield strength R_{p02%}=140 MPa, and a Poisson ratio v=0.35. The diameter d=4 mm, diameter D=12 mm, the outer diameter of the body 4 is 20 mm and the minimum membrane thickness tₘᵢₙ=0.78 mm. The fluid pressure p in the bore 6 ranges from 10 bar to 350 bar.

On the outer face of the membrane, i.e., where the strain gauge is to be placed, there are no normal stresses, i.e., σₓₓ=0. Deformation of the membrane by the fluid pressure is a bending deformation that generates strain ε_{yy} in the y direction, where

$${ε}_{y y} = \frac{1}{E} ( {σ}_{y y} - {υσ}_{zz} ) .$$

FIG. 3 is a longitudinal sectional view of the body 4 of the fluid device of FIGS. 1 and 2, showing the mesh created for the FEM analysis. The mesh created is finer at the region of interest, i.e., at the centre of the membrane 8. A pure hexahedron mesh has been used with eleven elements over the minimum thickness of the membrane.

FIG. 4 is a cross-sectional view of the body of the fluid device of FIGS. 1 and 2, showing an amplified deformation of the membrane 8 when a fluid pressure P in the bore 6 of 400 bar is applied. The deformation of the membrane is amplified by a factor of 1000.

FIG. 5 is a front view of the outer face 8.2 of the membrane 8 where the distribution of the stress σ_{yy} in the y direction on the outer surface 8.2 is illustrated. The central darker area corresponds to maximum values, in traction, of the stress σyy, close to 165 MPa. The outer darker area corresponds to lower values, in compression, of the stress σ_{yy}. The clearer area adjacent the outer darker areas towards the central darker area corresponds to lower values of the stress σ_{yy} where it inverts between compression and traction.

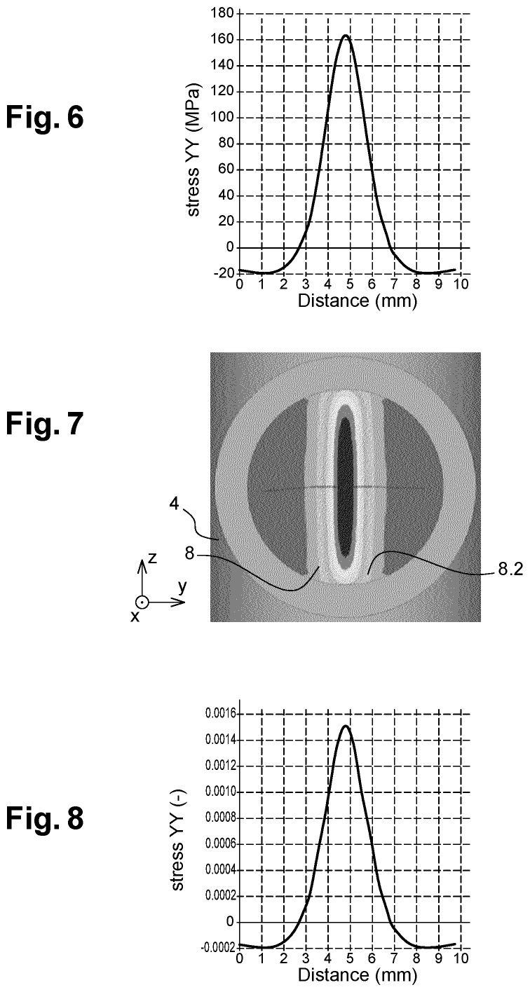

FIG. 6 is a graphic representation of the stress σ_{yy} along the central transversal direction visible in FIG. 5. We can see that the stress σ_{yy} shows negative values at a distance of at least 2 mm from a central position at about 5 mm, and positive and larger values at a central position.

More specifically, according to the FEM analysis, at the central position, we have σ_{yy}=163.78 MPa, σ_{zz}=50.25 MPa and σ_{zz}=0. Based on the above mentioned relation,

$${ε}_{y y} = \frac{1}{E} ( {σ}_{y y} - {υσ}_{zz} ) ,$$

the strain ε_{yy}=0.001507=0.151%.

FIG. 7 is a front view of the outer face 8.2 of the membrane 8 where the distribution of the strain ε_{yy} in the y direction on the outer face 8.2 is illustrated. It shows a distribution that is similar to the distribution of the stress σ_{yy} in FIG. 5.

FIG. 8 is a graphic representation of the strain ε_{yy} along the central transversal direction visible in FIG. 7. It shows a profile similar to the profile of the stress σ_{yy} in FIG. 6, with a maximum value of about 0.15% at a central position.

The above analysis has been made for different values of the minimum thickness of the membrane 0.5 mm<tₘᵢₙ<1 mm. For tₘᵢₙ=0.5 mm, the maximum strain ε_{yy}, at the central position, is of about 0.25% whereas for tₘᵢₙ=1 mm, it is of about 0.11%.

Also, the above analysis has been made for various values of the pressure p of the fluid, i.e., from 10 bar to 400 bar.

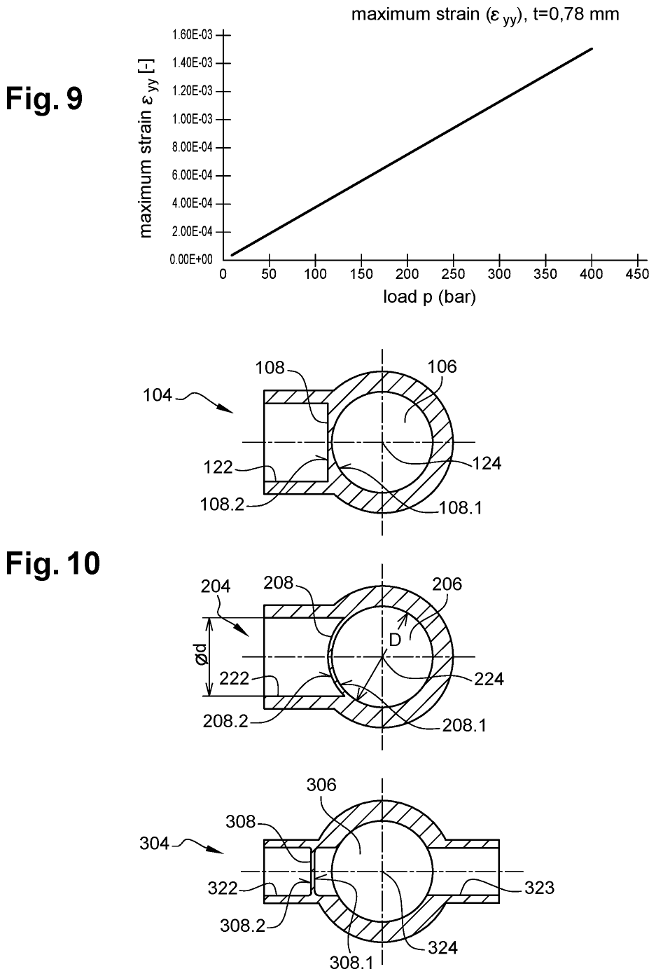

FIG. 9 is a graphic representation of the maximum strain ε_{yy}, for tₘᵢₙ=0.78 mm, depending on the fluid pressure p. We can observe a perfect linearity between the fluid pressure p and the maximum strain ε_{yy}.

The strain gauge previously disclosed in connection with FIG. 1 is in various instances placed at a position of the membrane where the deformation, i.e., the strain ε_{yy}, is maximum for obtaining a maximum sensitivity. For instance, in the case of the body of the fluid device of FIGS. 1 and 2, the strain gauge is in various instances positioned at a central position aligned with the longitudinal axis of the longitudinal bore.

A strain gauge usually shows a reduced active area, i.e., an area where flexion of the gauge is detected with the highest sensitivity. It is therefore advantageous to position that active area where the deformation of the membrane is maximum. With reference to the body of the fluid device of FIGS. 1 and 2, and the FEM analysis detailed in relation with FIGS. 3 to 9, the active area of the strain gauge is advantageously positioned at the centre of the outer face of the membrane.

A strain gauge also usually shows an axis of maximum sensitivity. It is therefore also advantageous to align that axis with the direction along which the strain in the membrane is maximum. With reference to the body of the fluid device of FIGS. 1 and 2, and the FEM analysis detailed in relation with FIGS. 3 to 9, that direction of maximum strain in the membrane at the outer face thereof is the y direction. It is therefore advantageous to align the axis of maximum sensitivity of the strain gauge with that axis.

A strain gauge is normally characterized by a deformation limit that is often of 0.2% or less. That deformation limit is a maximum strain on the contact face the strain gauge, i.e., the face that is intended to be adhered to the elements whose deformation is to be measured, for instance the outer face of the membrane. That deformation is also normally oriented along the axis of maximum sensitivity, if any. It is therefore advantageous to match the maximum strain of the membrane, at the outer surface therefore, with the corresponding maximum strain of the strain gauge.

For most of the strain gauges, the sensitivity is according the following relation:

$$\frac{Δ R}{{R}_{0}} = {e}^{g \cdot ε} - 1$$

where ΔR is a resistance variation, R₀ is a nominal resistance, ε is the gauge deformation and g is a gauge factor. For standard measuring applications, a gauge factor g of about 2 to 3 is common. In the present case, in particular for gas applications, like in a gas cylinder, where the pressure actively ranges over several hundreds of bar, e.g., between 5-10 bar and 400 bar, a higher gauge factor g is to be selected, for instance of at least 10, in various instances at least 20, for example up to 30.

As a matter of example, the strain gauge with the reference NG-UNI-V3-200K or the reference NG-UNI-V3-1 M of the company Nanolike® can be used. Such a strain gauge shows a width W of 6.5 mm and a length L of 7 mm. The active area shows a length a of 0.1 mm. It shows a nominal resistance of 200 kΩ or of 1 MΩ depending on the above reference. It shows a gauge factor g of 30.

Back with reference to FIGS. 6 and more particularly FIG. 8, the strain profile of the membrane at the outer face thereof shows a steep gradient with a maximum at a central position, i.e., where the membrane thickness is minimum. Such a steep gradient requires an accurate positioning of the strain gauge, i.e., for matching the active area of the strain gauge with the location of the maximum strain.

For reducing the requirement of an accurate positioning of the stain gauge, it can be advantageous to flatten the strain gradient mentioned here above. This can be achieved by increasing the diameter D of the longitudinal bore relative to the diameter d of the membrane.

FIG. 10 shows three exemplary variants to the body of the fluid device of FIGS. 1 and 2. The reference numbers used in FIGS. 1 and 2 are used for designating the same or corresponding elements, these numbers being however increased by 100, 200 and 300 respectively for the variants.

The first variant shows a body 104 that is very similar to the body 4 in FIGS. 1 and 2. It differs therefrom in the dimension of the diameter D of the longitudinal bore 106 which is substantially larger. For instance, the diameter D is larger than the diameter d of the outer face 108.2 of the membrane, corresponding to the transversal bore 122. As mentioned here above, this renders the strain gradient on the outer face 108.2 of the membrane 108 less steep, meaning that the requirement of positioning accuracy of the strain gauge is lowered.

The second variant shows a body 204 that is also very similar to the body 2 in FIGS. 1 and 2 and to the body 104 of the first variant. It differs therefrom in that the outer face 208.2 of the membrane 208 is not planar but well curved, for instance cylindrical. The membrane 208 shows then for instance a constant thickness. It shows a larger deformability for a given fluid pressure. It can be useful for applications with a lower maximum fluid pressure. The outer face 208.2 of the membrane 208 can be made by electro-erosion.

The third variant shows a body 304 that is similar to the body 2 in FIGS. 1 and 2 and to the bodies 104 and 204 of the first and second variants. The membrane 308 is planar on both faces, i.e., the inner face 308.1 and the outer face 308.2. To that end an opposed transversal bore 323 is formed through the body 306 and the longitudinal bore 306, thereby forming the inner face 308.1. The outer face 308.2 is formed by forming a transversal bore 322 as in the body 4 in FIGS. 1 and 2, and in the body 104 of the first variant.

1-15. (canceled)

16. A fluid device, said device comprising:
a body with a membrane extending in a mean plane and showing an inner face and an outer face;
a strain gauge arranged on the outer face of the membrane for measuring a deformation of the membrane when a fluid pressure is applied on the inner face thereof;
wherein a bore is formed in the body, extending along an axis parallel to the mean plane of the membrane and delimiting a passage for the fluid under pressure, in fluid connection with the inner face of the membrane;
wherein the strain gauge shows an axis of maximum sensitivity, the strain gauge being positioned on the outer face of the membrane such that the axis of maximum sensitivity is perpendicular to the axis of the bore.

17. The fluid device according to claim 16, wherein the bore delimiting a passage for the fluid under pressure forms the inner face of the membrane.

18. The fluid device according to claim 16, wherein the membrane is integrally formed with the body.

19. The fluid device according to claim 16, wherein the outer face of the membrane is circular and shows a diameter d.

20. The fluid device according to claim 19, wherein the bore shows a diameter D that is larger than the diameter d.

21. The fluid device according to claim 19, wherein the bore delimiting a passage for the fluid under pressure shows a diameter D that is less than the diameter d.

22. The fluid device according to claim 19, wherein the diameter d is comprised between 8 and 14 mm and the membrane shows at a central position a thickness t comprised between 0.5 and 1.0 mm.

23. The fluid device according to claim 16, wherein the outer face of the membrane is planar.

24. The fluid device according to claim 16, wherein the fluid device is designed for working at a fluid pressure of up to a maximum pressure Pₘₐₓ, the membrane being designed for showing a maximal strain at the maximum pressure Pₘₐₓ that is not greater than 0.2%.

25. The fluid device according to claim 16, wherein the bore delimiting a passage for the fluid under pressure is a first bore, a second bore being formed in the body and extending along an axis that is transversal, preferably perpendicular, to the axis of the first bore, and forming a cavity housing the membrane.

26. The fluid device according to claim 16, wherein the strain gauge shows a gauge factor g of one of the values:
at least 5;
at least 20;
at least 30.

27. The fluid device according to claim 16, wherein the strain gauge shows an electric resistance R which varies according to the following formula:
$$\frac{Δ R}{{R}_{0}} = {e}^{g \cdot ε} - 1$$
where R₀ is a nominal resistance of the strain gauge, g a gauge factor and e a stretching deformation of the strain gauge.

28. The fluid device according to claim 16, further comprising an electronic unit electrically connected to the strain gauge and configured for outputting a signal representative of the fluid pressure.

29. The fluid device according to claim 28, further comprising a temperature sensor of the fluid electrically connected to the electronic unit, wherein the electronic unit is configured for outputting a signal representative of the mass of fluid available based on a variation of pressure while the fluid is outputted.

30. The fluid device according to claim 16, further comprising a fluid shut-off valve.
